(19) United States
(12) Patent Application Publication
(10) Pub. No.: US 2024/0143477 A1
(43) Pub. Date: May 2, 2024

(54) MAINTENANCE SYSTEM, INFORMATION PROCESSING APPARATUS, MAINTENANCE METHOD, AND PROGRAM

(71) Applicant: Nippon Telegraph and Telephone Corporation, Tokyo (JP)

(72) Inventors: Yukitsugu SASAKI, Musashino-shi, Tokyo (JP); Kensuke TAKAHASHI, Musashino-shi, Tokyo (JP); Tsuyoshi Toyoshima, Musashino-shi, Tokyo (JP)

(21) Appl. No.: 18/274,508

(22) PCT Filed: Feb. 3, 2021
(86) PCT No.: PCT/JP2021/003883

§ 371 Date: Jul. 27, 2023

(51) Int. Cl. G06F 11/34

(52) U.S. Cl. CPC G06F 11/3476

(57) ABSTRACT

Provided is a maintenance system which includes a plurality of operating components (10) which autonomously operate by transmitting and receiving messages, and an information processing device (20). The operating component (10) includes an acquisition unit (17) that acquires observability data for grasping a state of the operating component (10), and a data transfer unit (16) which imparts an item common to different types of observability data and sends the data. The information processing device (20) includes a storage unit (21) which receives and stores the observability data, a correlation unit (22) which correlates different types of observability data on the basis of a common item included in the observability data, and a display unit (23) which displays the correlated observability data.

### TECHNICAL FIELD

The present invention relates to a maintenance system, an information processing device, a maintenance method, and a program.

### BACKGROUND ART

An autonomous control loop system that autonomously determines operations simply by incorporating new operating components into the system by modularizing functions and making them autonomous has been proposed. In the autonomous control loop system, a message is transmitted and received between operating components divided by functions. Each operating component autonomously operates on the basis of a received message. For example, the service maintenance work can be automated by utilizing a system of the autonomous control loop system incorporating operating components in which respective functions of the maintenance operation are made into parts for the service maintenance work.

### CITATION LIST

### Non Patent Literature

[NPL 1] Tomoki IKEGAYA, Kensuke TAKAHASHI, and Satoshi KONDOH, “Proposal of an information acquisition system for improving observability in an autonomous control loop system”, B-14-4, 2020 Society Conference of the Institute of Electronics, Information and Communication Engineers, Sep. 17, 2020

### SUMMARY OF INVENTION

### Technical Problem

In the autonomous control loop system, it is aimed to follow new services and changes in specifications of services at a low cost in a short period of time. Not only a mechanism that facilitates following when an operating component is added or a failure occurs, but also a mechanism that displays detailed data for a maintainer to determine a maintenance operation policy is required.

Observability has been proposed as a method for displaying detailed data to understand the behavior of the system. In observability, Logging/Metrics/Tracking is defined as three columns, and the behavior of the system can be understood by confirming the operating state, state and processing flow of the system. In order to understand the behavior of the system of the autonomous control loop system, in NPL 1, the operating components acquire observability information and display it to the operator.

However, if the observability information is displayed alone, the maintainer needs to retrieve necessary information from the displayed observability information. For example, even if a fault state between the operating components can be confirmed using Tracing data when the fault occurs in the operating components, it is necessary to check the logging data to check the failure occurrence time, and check the Metrics data to check the load information of the operating components.

The present invention has been made in view of the above, and an object of the present invention is to enable a maintainer to quickly check and understand the state of a system of the autonomous control loop system.

### Solution to Problem

A maintenance system according to an embodiment of the present invention includes a plurality of operating components which autonomously operate by transmitting and receiving messages, and an information processing device, in which each operating component includes an acquisition unit that acquires observability data for understanding a state of the operating component; and a data transfer unit which imparts an item common to different types of observability data and sends the data, and the information processing device includes a storage unit which receives and stores the observability data; a correlation unit which correlates different types of observability data on the basis of a common item included in the observability data; and a display unit which displays the correlated observability data.

### Advantageous Effects of Invention

According to the present invention, a maintainer can quickly check and understand the state of the system of the autonomous control loop system.

### BRIEF DESCRIPTION OF DRAWINGS

FIG. 1 is a diagram of an example of a configuration of a maintenance system including an information processing device of the present embodiment.

FIG. 2 is a diagram showing an example of an instruction for outputting a log.

FIG. 3 is a diagram showing an example of observability data.

FIG. 4 is a diagram showing an example of a configuration of the information processing device.

FIG. 5 is a diagram showing an example of correlating metrics and tracings to log.

FIG. 6 is a diagram showing an example of a display screen that displays observability data.

FIG. 7 is a sequence diagram showing an example of the flow of processing of the maintenance system.

FIG. 8 is a flow chart showing an example of the flow of processing of the information processing device.

FIG. 9 is a diagram showing an example of a hardware configuration of the information processing device.

### DESCRIPTION OF EMBODIMENTS

Hereinafter, embodiments of the present invention will be described using the drawings.

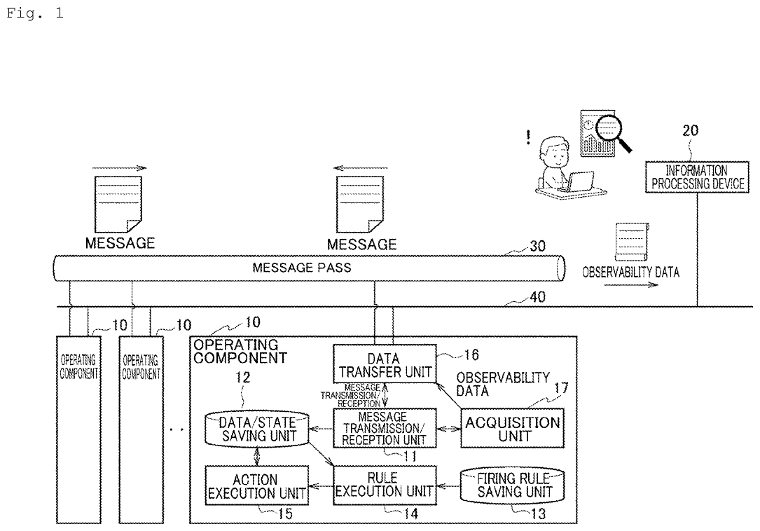

A maintenance system of an embodiment will be described with reference to FIG. 1. The maintenance system of the present embodiment adopts an autonomous control loop system in which a plurality of operating components 10 having no connection relationship actively check situations of a service and an alarm and autonomously determine and execute necessary processing.

The operating components 10 are devices or processes which autonomously operate by transmitting and receiving messages. The operating components 10 are each componentized in units of maintenance functions and each has a specific maintenance function. For example, the operating components 10 are classified into function types such as information collection, information processing, information analysis, test, recovery treatment, and a maintainer. The outline of the types of operating components are described below.

[Information collection] Information is collected from a cooperative service of a maintenance target.

[Information processing] Irreversible time series/character string processing such as noise removal, correlation calculation, feature/keyword extraction, and statistical processing, and visualization are performed.

Information analysis: Perform information analysis, such as classification, prediction, and state estimation for abnormality determination and clustering, and generate results of the analysis.

Testing: Generate and transmit test traffic.

[Recovery treatment] An operation for recovering a service is performed.

[Maintainer UI] A user interface for the maintainer to control the operating components is provided.

The maintenance system may not include all the operating components 10 of the aforementioned six function types, and may include operating components 10 other than the aforementioned function types, and a plurality of operation components 10 of the same function type may be provided. For example, when a cooperative service in which a plurality of services are linked is maintained, the aforementioned operating components 10 of the function types may be provided for each of the plurality of services.

The operating component 10 includes a message transmission/reception unit 11, a data/state saving unit 12, a firing rule saving unit 13, a rule execution unit 14, an action execution unit 15, a data transfer unit 16, and an acquisition unit 17. The operating component 10 transmits and receives messages between the operating components 10 via the message bus 30, and executes actions upon receiving messages addressed to itself. The action indicates the operation content of the operating component 10 and corresponds to each function when the operating component 10 is componentized in units of maintenance function. The operating component 10 transmits a message to a message bus 30 when execution of the action is successful and completes the operation without transmitting the message when execution of the action has failed.

The message transmission/reception unit 11 receives a message from the message bus 30 via the data transfer unit 16. When an action executed by the action execution unit 15 is successful, the message transmission/reception unit 11 creates a message based on the action execution result and transmits the message to the message bus 30 via the data transfer unit 16. When the action executed by the action execution unit 15 has failed, the message transmission/reception unit 11 does not transmit a message.

The data and status storage unit 12 holds data, such as a received message and a result of execution from the action execution unit 15, and a status. The action execution unit 15 may use data and a state of the data/state saving unit 12 at the time of executing an action. Further, the data/state saving unit 12 may hold data acquired from a common data saving unit that is not shown, or may temporarily hold data stored in the common data saving unit and store the data in the common data saving unit. The common data saving unit holds information to be used in common by each of the operating components 10.

The firing rule saving unit 13 holds a firing rule in which information for designating an action to be executed is individually defined for each operating component 10. A firing rule may designate an action to be executed according to the type of an operating component 10 of a transmission source of a received message. For example, an operating component 10 of “information processing” holds a firing rule for designating an action to be executed when a message with a transmission source that is an operating component 10 of “information collection” is received and a firing rule for designating an action to be executed when a message with a transmission source that is an operating component 10 of “test” is received.

The rule execution unit 14 fires a received message and instructs the action execution unit 15 to execute an action. Specifically, when the message transmission/reception unit 11 receives a message addressed thereto, the rule execution unit 14 acquires a firing rule saved in the firing rule saving unit 13 and notifies the action execution unit 15 of an action to be executed.

The action execution unit 15 receives the instruction from the rule execution unit 14 and executes the action notified of by the rule execution unit 14 with reference to data held by the data/state saving unit 12 and data held by the common data saving unit. When the action executed by the action execution unit 15 is successful, the message transmission/reception unit 11 transmits a message to the message bus 30 via the data transfer unit 16. The action executed by the action execution unit 15 may fail due to a factor such as lack of data. When the action execution unit 15 has failed to execute the action, a message is not sent.

The data transfer unit 16 is connected to the message bus 30 and the data bus 40, receives the message from the message bus 30 and transfers it to the message transmission/reception unit 11, sends the message received from the message transmission/reception unit 11 to the message bus 30, and transmits the observability data received from the acquisition unit 17 to the information processing device 20 via the data bus 40.

The acquisition unit 17 acquires observability data for understanding a state of the operating component 10 itself and transmits the acquired observability data to the data transfer unit 16. The observability data includes different types of data, for example, Logs, Metrics, and Tracing.

The log is an operation log indicating an operation situation of the operating component 10. The log includes, for example, an operation history such as, when and what kind of message was sent or received, when and what kind of action was executed, and when and what kind of error was output. The acquisition unit 17 periodically acquires the log output to the log file held by the operation component 10 at a predetermined timing, and transmits the log to the data transfer unit 16.

The metrics are resource information indicating the state of the operating component 10 itself. The metrics include, for example, information such as a CPU use rate, a memory use rate, and a traffic amount. The acquisition unit 17 periodically acquires resource information of the operating component 10 at a predetermined timing, using a function such as an operating system (OS), and transmits the resource information to the data transfer unit 16.

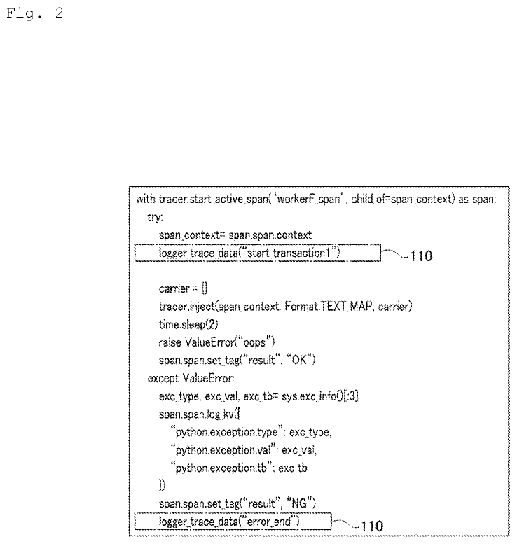

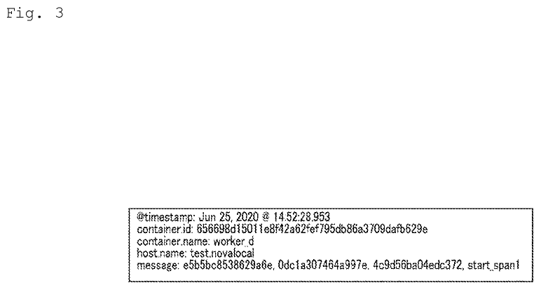

The tracing is information indicating a process flow linked between the operating components 10. Processing in each of the operating components 10 is expressed in a form of span. The span includes information such as a processing start time, a processing time, and a calling source. The tracing includes a span of processing started by firing of a certain operating component 10 and a span of processing of another operating component 10 accompanying it, and shows a flow of a series of processing of the maintenance system. The acquisition unit 17 acquires cooperation information between the operating components 10 from the message transmitted and received by the message transmission/reception unit 11, and transmits the cooperation information to the data transfer unit 16. A processing flow linked between the operating components 10 is acquired on the basis of the source and destination operating components 10 that are set in the messages transmitted and received between the operating components 10 When sending the observability data, the data transfer unit 16 imparts an item which is common between different kinds of observability data to the observability data acquired from the acquisition unit 17. For example, the data transfer unit 16 imparts a container ID, a container name, and a host name which are items common to metrics, and a transaction ID, a trace ID, and a span ID which are items common with tracing to the log. More specifically, as shown in FIG. 2, an instruction 110 for outputting a log in a common log format is added. When the instruction 110 is called, the data transfer unit 16 outputs a log in a common log format. FIG. 3 shows an example of observability data (log) that is sent from the data transfer unit 16. The log shown in FIG. 3 includes a time stamp, a container ID, a container name, a host name, and a message, and a transaction ID, a span ID, and a character string are included in the message. The observability data may include information about services to be maintained and information about operations performed by the operating components 10.

Since each of the operating components 10 has the common data transfer unit 16 and the acquisition unit 17, the log can be output in the same format, and correlation of different kinds of observability data by an information processing device 20 to be described later can be performed. This can quickly cope with the addition of a new operating component 10 to a maintenance system. Also, even when the acquisition unit 17 acquires observability data by an existing technique, because the data transfer unit 16 imparts a common item, it is not necessary to modify the acquisition unit 17.

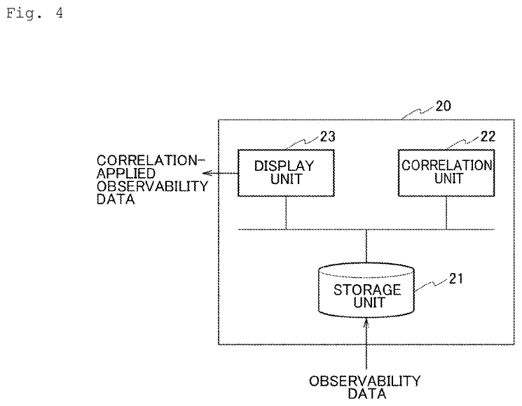

Next, the information processing device 20 will be described with reference to FIG. 4. The information processing device 20 correlates the observability data received from each operating component 10 and presents the operating state of the operating component 10 to the maintainer. The information processing device 20 shown in FIG. 4 includes a storage unit 21, a correlation unit 22, and a display unit 23. The storage unit 21, the correlation unit 22, and the display unit 23 may be constituted by separate devices.

The storage unit 21 stores observability data sent by each of the operating components 10 by imparting classification information of a log, metrics, or tracing.

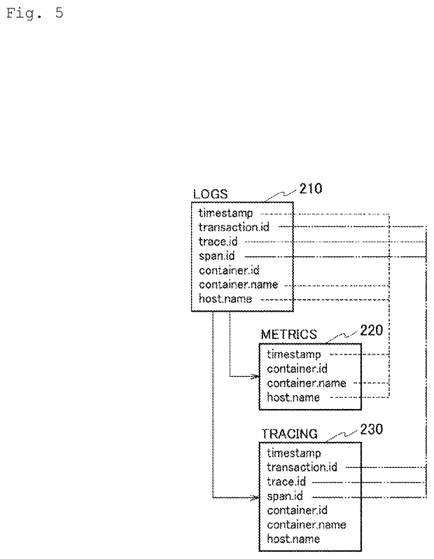

The correlation unit 22 correlates different types of observability data on the basis of a common item of the observability data. FIG. 5 shows an example of correlating the metrics and the tracing to the log. The log includes parameters of a timestamp, a transaction ID, a trace ID, a span ID, a container ID, a container name, and a host name. The metrics include parameters of a time stamp, a container ID, a container name, and a host name. The tracing includes parameters of a timestamp, a transaction ID, a trace ID, a span ID, a container ID, a container name, and a host name In the example of FIG. 5, the correlation unit 22 correlates the log 210 and the metrics 220 on the basis of the time stamp, the container name, and the host name, correlates the log 210 and the tracing 230 on the basis of the transaction ID, the trace ID and the span ID to extract a group of correlated observability data.

A priority rule may correlate the metrics and the tracing to the logs, correlate the logs and the tracing to the metrics, or correlate the logs and the metrics to the tracing. For example, the priority of the log is set highest, a log when a certain error occurs is extracted, and the metrics having the same container name and host name as the log are correlated with the tracing having the same transaction ID, trace ID, and span ID as the log. Alternatively, the priority of metrics is set highest, the metrics of the operating component 10 in a state of high load are extracted, and the log and tracing are correlated on the basis of the time stamp, the container name, and the host name indicated by the metrics. Alternatively, the priority of tracing is set highest, the log is correlated on the basis of the tracing ID of tracing of a series of processing, and the metrics are correlated on the basis of the time stamp of tracing, the container name, and the host name. A maintainer can arbitrarily set the priority rule.

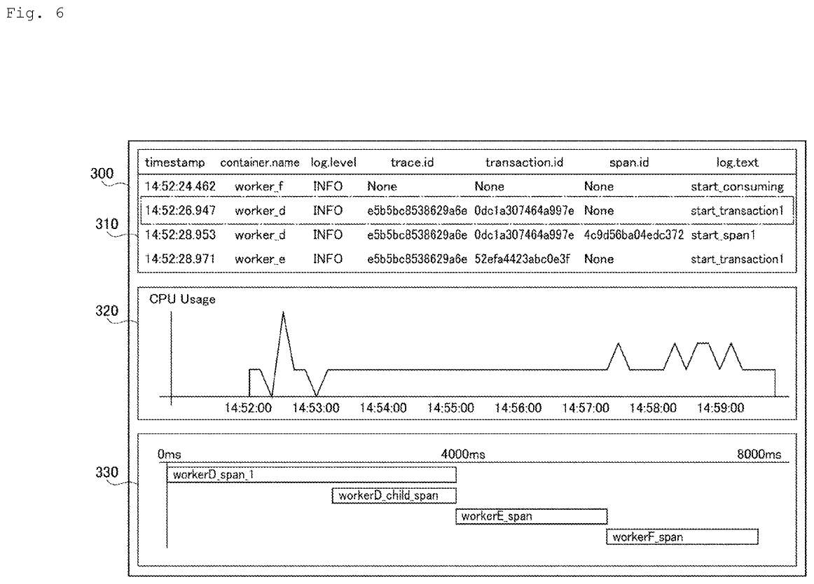

The display unit 23 arranges different kinds of observability data for each group and displays them in a list. FIG. 6 shows an example of a display screen. The display screen 300 of FIG. 6 includes a log display area 310, a metrics display area 320, and a tracing display area 330. Metrics and tracing correlated to the log selected in the log display area 310 are displayed in the metrics display area 320 and the tracing display area 330.

The display unit 23 may constitute the display screen 300 according to the priority rule. For example, when the priority of the log is set to the highest, the display unit 23 displays a list of logs and receives the selection of the log. When a maintainer selects a certain log, the metrics and tracing correlated to the selected log are displayed in the display screen.

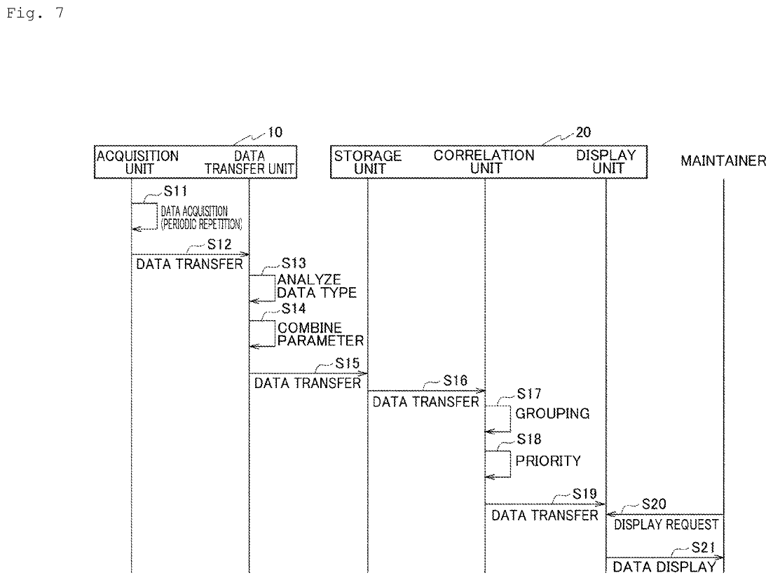

Next, the operation of the maintenance system will be described with reference to the sequence diagram of FIG. 7. Although only one operating component 10 is shown in FIG. 7, the information processing device 20 receives observability data from a plurality of operating components 10.

The acquisition unit 17 acquires the observability data of its own operating component 10 at a predetermined timing in step S11, and transmits the acquired observability data to the data transfer unit 16 in step S12.

The data transfer unit 16 analyzes the observability data to determine the data type of the observability data in step S13, imparts common to the observability data in step S14, and transmits it to the information processing device 20 via the data bus 40 in step S15.

In step S16, the storage unit 21 receives and stores the observability data, and transmits the observability data to the correlation unit 22. The storage unit 21 may notify the correlation unit 22 that the observability data has been received.

A correlation unit 22 correlates different types of observable data on the basis of information included in the observable data in step S17, prioritizes the correlated observable data in step S18, and the correlated observability data are transmitted to a display part 23 in step S19. The correlation unit 22 may store the correlated observability data in the storage unit 21, and may notify the display unit 23 that the observability data are correlated.

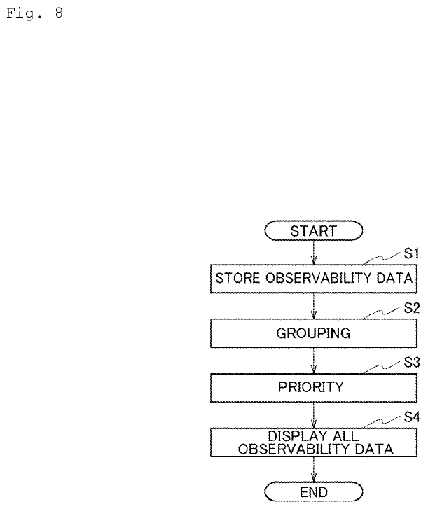

When a display request is received from a maintainer in step S20, the display unit 23 displays the observability data in a form corresponding to the request in step S21. For example, the display unit 23 displays a list of observability data related to a service when receiving a display request designating the service from the maintainer, or displays a list of observability data related to the operating component 10 when receiving a display request designating the operating component 10 from the maintainer. When displaying a list of observability data, the display unit 23 may display a list of observability data of a kind having a high priority, receive selection of observability data, receive selection of observability data from the list, and display observability data correlated with the selected observability data. Next, the operation of the information processing device 20 will be described with reference to the flowchart of FIG. 8.

In step S1, the storage unit 21 receives and stores the observability data.

In step S2, the correlation unit 22 correlates the observability data on the basis of a common item.

In step S3, the correlation unit 22 imparts priority to the observability data according to the priority rule.

In step S4, the display unit 23 displays correlated observability data on the basis of an instruction from a maintainer.

As described above, the maintenance system of the present embodiment includes a plurality of operating components 10 that autonomously operate by transmitting and receiving messages, and the information processing device 20. The operating component 10 includes an acquisition unit 17 that acquires observability data for grasping the state of the operating component 10 itself, and a data transfer unit 16 that imparts common items to different types of observability data and sends them. The information processing device 20 includes a storage unit 21 that receives and stores observability data, a correlation unit 22 that correlates different types of observability data based on common items included in the observability data, and a display unit 23 that displays the correlated observability data By displaying different kinds of observability data correlated with each other, a maintainer can quickly grasp the operation situation and state of the operating component 10 and cooperation between the operating components 10, and can grasp the flow of the operation and the autonomous control executed by the maintenance system for the fault detection and service recovery processing of the service to be maintained.

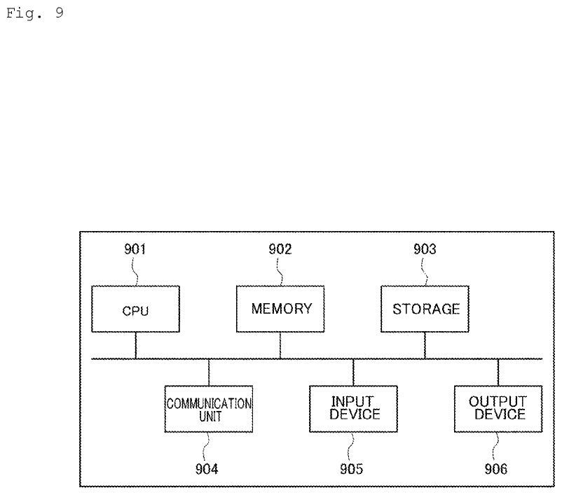

As the information processing device 20 described above, a general-purpose computer system including a central processing unit (CPU) 901, a memory 902, a storage 903, a communication device 904, an input device 905, and an output device 906 as illustrated in FIG. 9, for example, can be used. The information processing device 20 is realized by the CPU 901 executing a predetermined program loaded on the memory 902 in the computer system. This program can be recorded on a computer-readable recording medium such as a magnetic disk, an optical disc, or a semiconductor memory, or can be distributed via a network.

### REFERENCE SIGNS LIST

10 Operating component
11 Message transmission/reception unit
12 Data/state storage unit
13 Firing rule saving unit
14 Rule execution unit
15 Action execution unit
16 Data transfer unit
17 Acquisition unit
20 Information processing device
21 Storage unit
22 Correlation unit
23 Display unit
30 Message bus
40 Data Bus

1. A maintenance system comprising a plurality of operating components which autonomously operate by transmitting and receiving messages, and an information processing device,
wherein each operating component includes one or more processors configured to:
acquire observability data for grasping a state of the operating component; and
impact an item common to different types of observability data and send the data, and
the information processing device includes one or more processors configured to:
receive and store the observability data;
correlate different types of observability data on the basis of a common item included in the observability data; and
display the correlated observability data.

2. The maintenance system according to claim 1,
wherein the observability data is a log that indicates an operation situation of the operating component, a metric that indicates a state of the operating component, and tracing which indicates cooperation between the operating components.

3. The maintenance system according to claim 2,
wherein the observability data includes information indicating the operating component, and the log includes information on cooperation between the operating components included in the tracing or the metrics.

4. The maintenance system according to claim 1,
wherein the information processing device is configured to extract observability data of a type with high priority from the observability data, and correlate other types of observability data with the observability data of the type with high priority.

5. An information processing device which processes observability data for understanding a state of a plurality of operating components sent by each of the plurality of operating components that operate autonomously by transmitting and receiving a message, the information processing device comprising one or more processors configured to:
receive and store the observability data;
correlate different types of observability data on the basis of a common item included in the observability data; and
display the correlated observability data.

6. A maintenance method performed by a maintenance system which includes a plurality of operating components that operate autonomously by transmitting and receiving a messages, and an information processing device, comprising
acquiring, by each operating component, observability data for understanding a state of the operating component, and
imparting, by each operating component, a common item to different kinds of observability data and sends the data, and
receiving, by the information processing device, the observability data,
correlating, by the information processing device, different types of observability data on the basis of common items included in the observability data, and
displaying, by the information processing device, the correlated observability data.

7. A non-transitory computer readable medium storing one or more instructions causing a computer to function as each part of the information processing device according to claim 5.

8. The information processing device according to claim 5,
wherein the observability data is a log that indicates an operation situation of the operating component, a metric that indicates a state of the operating component, and tracing which indicates cooperation between the operating components.

9. The information processing device according to claim 8,
wherein the observability data includes information indicating the operating component, and the log includes information on cooperation between the operating components included in the tracing or the metrics.

10. The information processing device according to claim 5, configured to extract observability data of a type with high priority from the observability data, and correlate other types of observability data with the observability data of the type with high priority.

11. The maintenance method according to claim 6,
wherein the observability data is a log that indicates an operation situation of the operating component, a metric that indicates a state of the operating component, and tracing which indicates cooperation between the operating components.

12. The maintenance method according to claim 11,
wherein the observability data includes information indicating the operating component, and the log includes information on cooperation between the operating components included in the tracing or the metrics.

13. The maintenance method according to claim 6, comprising:
extracting, by the information processing device, observability data of a type with high priority from the observability data, and
correlating, by the information processing device, other types of observability data with the observability data of the type with high priority.
